(19) United States
(12) Patent Application Publication
(10) Pub. No.: US 2023/0062467 A1
(43) Pub. Date: Mar. 2, 2023

(54) ROBUST VEHICLE SECUREMENT SYSTEM FOR BATTERY ELECTRIC VEHICLES

(71) Applicants: Abhilash Gudapati, Troy, MI (US); Abhilash Valson, Farmington Hills, MI (US); Marian M. Mirowski, West Bloomfield, MI (US); Jerome M. Hendler, JR., Rochester, MI (US)

(72) Inventors: Abhilash Gudapati, Troy, MI (US); Abhilash Valson, Farmington Hills, MI (US); Marian M. Mirowski, West Bloomfield, MI (US); Jerome M. Hendler, JR., Rochester, MI (US)

(21) Appl. No.: 17/458,803

(22) Filed: Aug. 27, 2021

(51) Int. Cl. B60L 15/20; B60L 3/00

(52) U.S. Cl. CPC B60L 15/2018; B60L 3/0076

(57) ABSTRACT

An electric drive module (EDM) of an electrified vehicle includes a park pawl configured to engage/disengage a park gear of the vehicle in response to actuation by an electric motor, and a power inverter module (PIM) comprising a supercapacitor configured to store electrical energy, and control logic configured to control the park pawl, the electric motor, and the supercapacitor, and an electrified vehicle control unit (EVCU) configured to control operation of the vehicle and in communication with the PIM and an electronic park brake via a controller area network (CAN), wherein the electronic park brake is configured to selectively apply a braking force to a driveline of the vehicle, wherein the system is able to secure the vehicle in the event of a plurality of different electrical system malfunctions without the use of additional electric motors and/or battery systems that increase vehicle weight and packaging.

### FIELD

The present application generally relates to battery electric vehicles (BEVs) and, more particularly, to robust vehicle securement techniques for BEVs.

### BACKGROUND

A park pawl system typically comprises a park pawl that is selectively engaged/disengaged (e.g., to a toothed wheel) to physically lockup a driveline of a vehicle. In battery electric vehicles (BEVs), such as those including an electric drive module (EDM) for propulsion, park electronic securement (e-securement) can be a potential drivability issue. This may occur when the BEV is in drive/neutral/reverse and there is an electrical system malfunction that prevents the park pawl system from being controlled. Conventional solutions to this problem include the addition of excess hardware, such as additional electric motor(s) and spring loads, but this could significantly increase costs and cause packaging/weight issues and reduce reliability and longevity. In addition, an electric park brake alone may sometimes be incapable of holding a heavier BEV stationary, particularly on a steep grade. Accordingly, while such conventional vehicle securement systems do work well for their intended purpose, there exists an opportunity for improvement in the relevant art.

### SUMMARY

According to one example aspect of the invention, a robust vehicle securement system for a battery electric vehicle is presented. In one exemplary implementation, the system comprises an electric drive module (EDM) of the vehicle, the EDM comprising a park pawl configured to engage/disengage a park gear of the vehicle in response to actuation by an electric motor, and a power inverter module (PIM) comprising a supercapacitor configured to store electrical energy, and control logic configured to control the park pawl, the electric motor, and the supercapacitor, and an electrified vehicle control unit (EVCU) configured to control operation of the vehicle and in communication with the PIM and an electronic park brake via a controller area network (CAN), wherein the electronic park brake is configured to selectively apply a braking force to a driveline of the vehicle, wherein the system is able to secure the vehicle in the event of a plurality of different electrical system malfunctions without the use of additional electric motors and/or battery systems that increase vehicle weight and packaging.

In some implementations, the park pawl, the supercapacitor, and the control logic are all housed as a single unit. In some implementations, when the park pawl has been properly disengaged and the vehicle is operating, the system determines whether there is a reason to secure the vehicle.

In some implementations, the reason to secure the vehicle is a driver park request, upon which the EVCU receives the driver park request and requests the PIM to engage the park pawl to secure the vehicle. In some implementations, the reason to secure the vehicle is based on an EVCU securement strategy that determines a need to secure the vehicle for safety reasons, upon which the EVCU requests the PIM to engage the park pawl to secure the vehicle. In some implementations, the reason to secure the vehicle is an EVCU malfunction of the plurality of different electrical system malfunctions, upon which the PIM controls the park pawl and engages the park pawl in response to a driver shift to park or a calibratable timeout to secure the vehicle. In some implementations, the reason to secure the vehicle is a PIM malfunction of the plurality of different electrical system malfunctions, upon which the EVCU requests the electronic park brake to apply the braking force to the driveline of the vehicle to secure the vehicle. In some implementations, the reason to secure the vehicle is a system wide 12 volt loss malfunction of the plurality of different electrical system malfunctions.

In some implementations, when the vehicle speed is greater than a threshold, the PIM uses back EMF of the EV electric motor and stores energy in the supercapacitor and the PIM then engages the park pawl when the vehicle speed falls below the threshold to secure the vehicle using the stored energy in the supercapacitor. In some implementations, when the speed is less than a threshold, the PIM controls the park pawl and receives power from a high voltage battery system of the vehicle and the PIM engages the park pawl when the vehicle speed is less than the threshold to secure the vehicle.

According to another example aspect of the invention, a robust vehicle securement method for a battery electric vehicle is presented. In one exemplary implementation, the method comprises providing an electric drive module (EDM) of the vehicle, the EDM comprising a park pawl configured to engage/disengage a park gear of the vehicle in response to actuation by an electric motor, and a power inverter module (PIM) comprising a supercapacitor configured to store electrical energy, and control logic configured to control the park pawl, the electric motor, and the supercapacitor, providing an electrified vehicle control unit (EVCU) configured to control operation of the vehicle and in communication with the PIM and an electronic park brake via a controller area network (CAN), wherein the electronic park brake is configured to selectively apply a braking force to a driveline of the vehicle, and selectively controlling, by the EVCU or the PIM, the park pawl to engage/disengage for selective securement of the vehicle, wherein the method is able to secure the vehicle in the event of a plurality of different electrical system malfunctions without the use of additional electric motors and/or battery systems that increase vehicle weight and packaging.

In some implementations, the park pawl, the supercapacitor, and the control logic are all housed as a single unit. In some implementations, the method further comprises when the park pawl has been properly disengaged and the vehicle is operating, determining whether there is a reason to secure the vehicle.

In some implementations, the reason to secure the vehicle is a driver park request, and further comprising receiving, by the EVCU, the driver park request and requesting, by the EVCU, the PIM to engage the park pawl to secure the vehicle. In some implementations, the reason to secure the vehicle is based on an EVCU securement strategy that further comprises determining, by the EVCU, a need to secure the vehicle for safety reasons and requesting, by the EVCU, the PIM to engage the park pawl to secure the vehicle. In some implementations, the reason to secure the vehicle is an EVCU malfunction of the plurality of different electrical system malfunctions, and further comprising controlling, by the PIM, the park pawl and engaging, by the PIM, the park pawl in response to a driver shift to park or a calibratable timeout to secure the vehicle. In some implementations, the reason to secure the vehicle is a PIM malfunction of the plurality of different electrical system malfunctions, and further comprising requesting, by the EVCU, the electronic park brake to apply the braking force to the driveline of the vehicle to secure the vehicle. In some implementations, the reason to secure the vehicle is a system wide 12 volt loss malfunction of the plurality of different electrical system malfunctions.

In some implementations, when the vehicle speed is greater than a threshold, the PIM uses back EMF of the EV electric motor and stores energy in the supercapacitor and the PIM then engages the park pawl when the vehicle speed falls below the threshold to secure the vehicle using the stored energy in the supercapacitor. In some implementations, when the speed is less than a threshold, the PIM controls the park pawl and receives power from a high voltage battery system of the vehicle and the PIM engages the park pawl when the vehicle speed is less than the threshold to secure the vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a battery electric vehicle (BEV) comprising a robust vehicle securement system according to the principles of the present application; and

FIGS. 2A-2B are flow diagrams of an example robust vehicle securement method for a BEV according to the principles of the present application.

### DESCRIPTION

As previously mentioned, vehicle securement (i.e., park securement) issues could potentially occur when a battery electric vehicle (BEV) is in drive/neutral/reverse and there is an electrical system malfunction that prevents a park pawl system from being controlled. Conventional solutions to this problem include the addition of excess hardware, such as additional electric motor(s) and spring loads, but this could drastically increase costs and causes packaging/weight issues.

As a result, robust vehicle securement techniques that provide park e-securement in a BEV with the use of minimal additional hardware are presented. Some additional hardware may be required because in heavier BEV vehicles (e.g., capable of towing), the BEV's electric park brake could sometimes be incapable of holding the BEV secure during certain electrical system malfunctions, particularly while the BEV is on a steep grade. These techniques incorporate a supercapacitor (or ultracapacitor) in the same packaging of an electronic drive module (EDM), which includes the physical park pawl and its electric motor. Redundant controller area network (CAN) networking is also provided such that an electrified vehicle control unit (EVCU), the EDM, and an electronic shifter module are all in communication to prevent a single communication malfunction rendering the system inoperable.

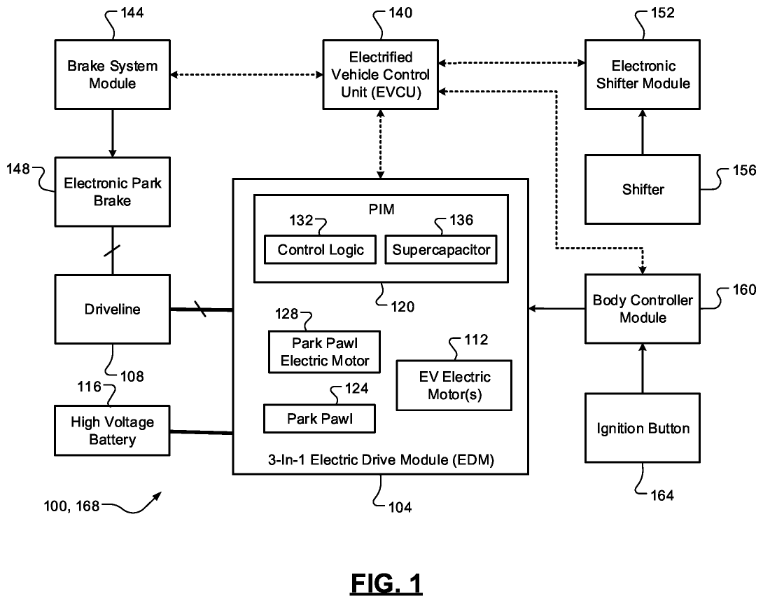

Referring now to FIG. 1, a functional block diagram of a BEV 100 (hereinafter, “vehicle 100”) having an example robust vehicle securement system according to the principles of the present application is illustrated. The vehicle 100 generally comprises a “3-In-1” electric drive module (EDM) 104 configured to generate and transfer drive torque to a driveline 108 for vehicle propulsion. It will be appreciated that there could also be a transmission integrated in the EDM 104 or separate from the EDM 104 that is configured to transfer the generated drive torque to the driveline 108.

The EDM 104 generally comprises one or more EV electric motors 112 (e.g., electric traction motors) selective connectable to a high voltage battery system 116 for powering the electric motor(s) 112, a physical park pawl 124 that is engaged/disengaged by a park pawl electric motor 128 or other suitable electric machine. A power inverter module (PIM) 120 further comprises its own control logic 132 and also a supercapacitor (or ultracapacitor) 136 as a redundant power source (or emergency power supply, EPS) in the event of certain electrical malfunctions. An electrified vehicle control unit (EVCU) 140 controls the EDM 104 to generate a desired amount of drive torque to meet a driver demand (e.g., input via an accelerator pedal).

The EVCU 140 is typically powered by a low voltage battery (e.g., 12 volts, not shown), which could also be utilized to power one or more accessory loads (not shown) of the vehicle 100. The EVCU 140 communicates with the EDM 104 and other components via a CAN (e.g., the dashed communication lines connecting various systems). Specifically, the EVCU 140 communicates with the EDM 104, a brake system module 144, and electronic shift module 152, and a body controller module 166. The brake system module 144 is hardwired to and configured to control an electronic park brake 148 to selectively apply a braking force to the driveline 108 to achieve a park state. The electronic shifter module 152 is hardwired to and configured to receive driver input via a shifter 156 (park, drive/neutral/reverse, etc.). The body controller module 160 is configured to provide an ignition request/command to the EDM 104 in response to driver input via a hardwired ignition button 164. The majority of these components are also generally referred to as “an electrical system 168” of the vehicle 100.

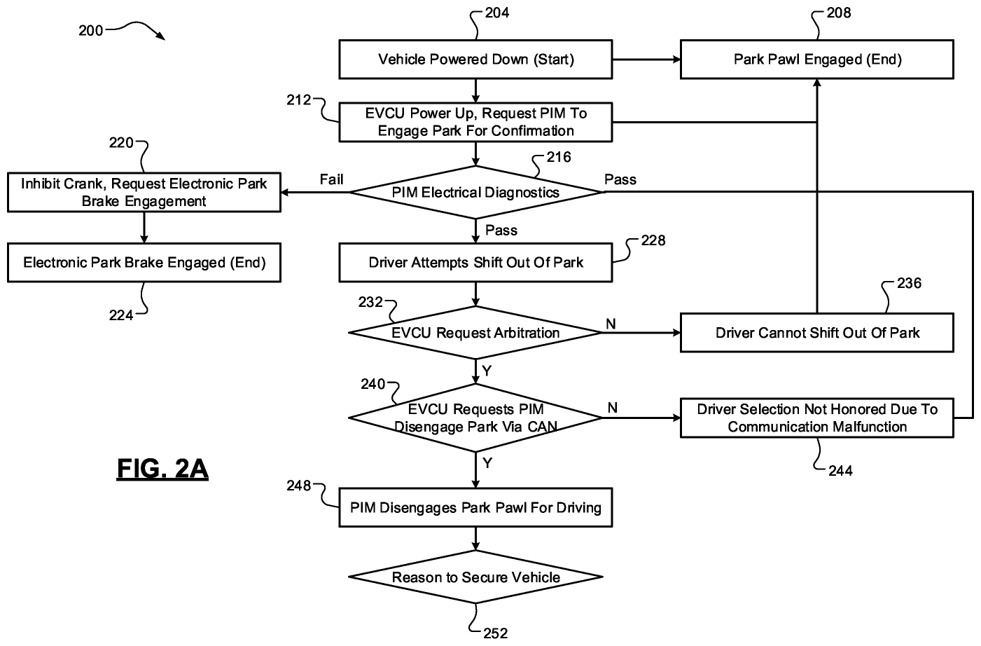

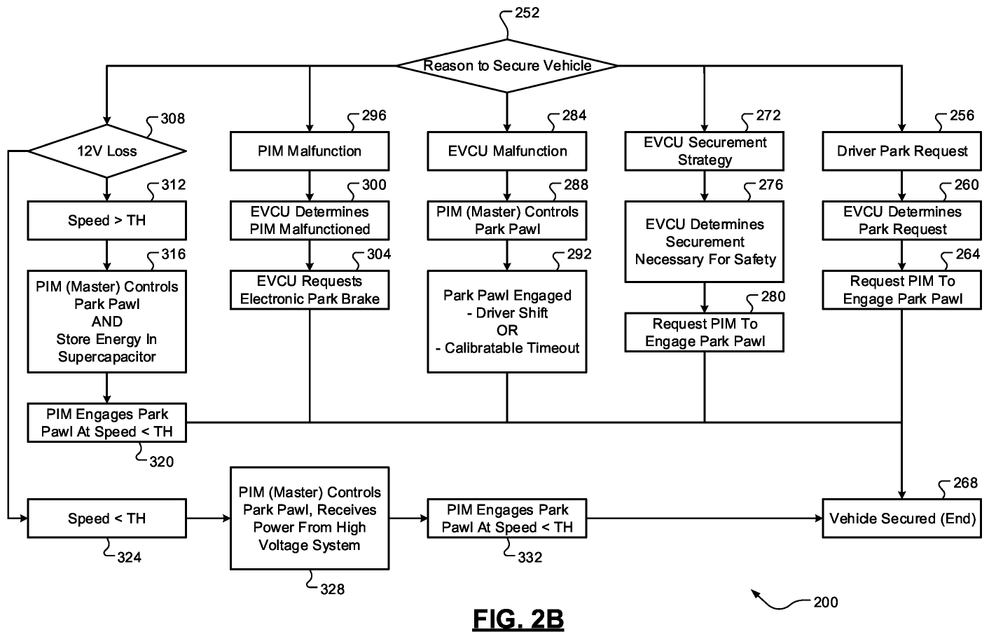

Referring now to FIGS. 2A-2B, flow diagrams of an example robust vehicle securement method 200 for a BEV (e.g., vehicle 100) according to the principles of the present application are illustrated. At 204, the method 200 begins in FIG. 2A with the vehicle 100 being powered down. In this state, the park pawl 124 is engaged at 208 and the method 200 ends. However, the EVCU 140 could be powered up at 212 (e.g., in response to a drive start request), and the EVCU 140 requests the PIM 120 to engage park for confirmation. At 216, electrical diagnostics of the PIM 120 are performed (e.g., communication checks). When these diagnostics pass and the driver does not shift out of park, the park pawl 124 remains engaged at 208 and the method 200 ends.

Conversely, when these diagnostics fail, the method 200 proceeds to 220 where cranking (vehicle starting) is inhibited) and the electronic park brake 148 is requested to engage to via the brake system module 144 to secure the vehicle 100 and the method 200 ends at 224 when the electronic park brake 148 is engaged. Alternatively, when these diagnostics pass at 216 and the driver attempts to shift out of park at 228, the EVCU 140 then at 232 performs an arbitration of the request to determine whether it is valid or should be executed. When false, the method 200 proceeds to 236 where the driver cannot shift out of park and the method 200 then ends at 208 with the park pawl 124 being engaged.

When the arbitration is true (i.e., a valid request to shift out of park), the method 200 proceeds to 240 where the EVCU 140 requests the PIM 120 to disengage park via the CAN. When this request fails (false), the method 200 proceeds to 244 where the driver selection is not honored due to a communication malfunction and the method 200 ends at 208 with the park pawl 124 being engaged. When the request is successful (true), the method 200 proceeds to 248 where the PIM 120 disengages the park pawl 124 for driving of the vehicle 100. At 252, a determination is made during vehicle 100 operation as to whether there is a reason to secure the vehicle 100. There could be a plurality of different reasons to do so, ranging from a normal driver request to various electrical system malfunctions.

At 252, the method 200 continues in FIG. 2B, and a first securement scenario involves a driver park request at 256. At 260, the EVCU 140 determines/receives/validates the park request, and at 264 the EVCU 140 requests the PIM 120 to engage the park pawl 124, after which the vehicle is secured at 268 and the method 200 ends. In a second securement scenario, the EVCU 140 performs an EVCU securement strategy at 272. This includes the EVCU determining that securement of the vehicle 100 is necessary for safety reasons at 276. At 280, the EVCU 140 requests the PIM 120 to engage the park pawl 124 and the method 200 ends at 268 with the vehicle 100 being secured.

In a third scenario, the EVCU 140 malfunctions at 284 and the PIM 120 takes controls (master/slave) the park pawl 124 at 288. At 292, the PIM 120 engages the park pawl 124 in response to a driver shift to park or a calibratable timeout (after the initial request), and the method 200 ends at 268 with the vehicle 100 being secured.

In a fourth scenario, the PIM 120 malfunctions at 296 and the EVCU 140 then determines/verifies/validates that the PIM 120 malfunctioned at 300. At 304, the EVCU 140 requests that the electronic park brake 148 be applied (via the brake control module 144) and the method 200 then ends at 268 with the vehicle 100 being secured.

Finally in a fifth scenario, there is a 12 volt system wide power loss at 308. When the vehicle speed exceeds a threshold (e.g., ˜10.5 kph), the PIM 120 controls (master/slave) the park pawl 124 and energy is stored in the supercapacitor 136. At 320, the PIM 120 will engage the park pawl 124 when the vehicle speed falls below the threshold, and the method 200 then ends at 268 with the vehicle 100 being secured. Alternatively, when the vehicle speed is initially below the threshold at 324, the PIM 120 controls (master/slave) the park pawl 124 and receives power from the high voltage battery 116 (e.g., via a DC-DC converter step-down). At 332, the PIM 120 will engage the park pawl 124 when the vehicle speed is below the threshold, which it already may be. The method 200 then ends at 268 with the vehicle 100 being secured.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A robust vehicle securement system for a battery electric vehicle, the system comprising:
an electric drive module (EDM) of the vehicle, the EDM comprising:
a park pawl configured to engage/disengage a park gear of the vehicle in response to actuation by an electric motor, and
a power inverter module (PIM) comprising a supercapacitor configured to store electrical energy, and control logic configured to control the park pawl, the electric motor, and the supercapacitor; and
an electrified vehicle control unit (EVCU) configured to control operation of the vehicle and in communication with the PIM and an electronic park brake via a controller area network (CAN), wherein the electronic park brake is configured to selectively apply a braking force to a driveline of the vehicle,
wherein the system is configured to secure the vehicle in the event of a plurality of different electrical system malfunctions without the use of additional electric motors and/or battery systems.

2. The system of claim 1, wherein when the park pawl has been properly disengaged and the vehicle is operating, the system determines whether there is a reason to secure the vehicle.

3. The system of claim 2, wherein the reason to secure the vehicle is a driver park request, upon which the EVCU receives the driver park request and requests the PIM to engage the park pawl to secure the vehicle.

4. The system of claim 2, wherein the reason to secure the vehicle is a system wide 12 volt loss malfunction of the plurality of different electrical system malfunctions.

5. The system of claim 4, wherein when the vehicle speed is greater than a threshold, the PIM uses back EMF of the EV electric motor and stores energy in the supercapacitor and the PIM then engages the park pawl when the vehicle speed falls below the threshold to secure the vehicle using the stored energy in the supercapacitor.

6. The system of claim 4, wherein when the vehicle speed is less than a threshold, the PIM controls the park pawl and receives power from a high voltage battery system of the vehicle and the PIM engages the park pawl when the vehicle speed is less than the threshold to secure the vehicle.

7. The system of claim 1, wherein the park pawl, the supercapacitor, and the control logic are all housed as a single unit.

8. The system of claim 2, wherein the reason to secure the vehicle is based on an EVCU securement strategy that determines a need to secure the vehicle for safety reasons, upon which the EVCU requests the PIM to engage the park pawl to secure the vehicle.

9. The system of claim 2, wherein the reason to secure the vehicle is an EVCU malfunction of the plurality of different electrical system malfunctions, upon which the PIM controls the park pawl and engages the park pawl in response to a driver shift to park or a calibratable timeout to secure the vehicle.

10. The system of claim 2, wherein the reason to secure the vehicle is a PIM malfunction of the plurality of different electrical system malfunctions, upon which the EVCU requests the electronic park brake to apply the braking force to the driveline of the vehicle to secure the vehicle.

11. A robust vehicle securement method for a battery electric vehicle, the method comprising:
providing an electric drive module (EDM) of the vehicle, the EDM comprising:
a park pawl configured to engage/disengage a park gear of the vehicle in response to actuation by an electric motor, and
a power inverter module comprising a supercapacitor configured to store electrical energy, and control logic configured to control the park pawl, the electric motor, and the supercapacitor;
providing an electrified vehicle control unit (EVCU) configured to control operation of the vehicle and in communication with the PIM and an electronic park brake via a controller area network (CAN), wherein the electronic park brake is configured to selectively apply a braking force to a driveline of the vehicle; and
selectively controlling, by the EVCU or the PIM, the park pawl to engage/disengage for selective securement of the vehicle,
wherein the method is able to secure the vehicle in the event of a plurality of different electrical system malfunctions without the use of additional electric motors and/or battery systems that increase vehicle weight and packaging.

12. The method of claim 11, wherein the park pawl, the supercapacitor, and the control logic are all housed as a single unit.

13. The method of claim 11, further comprising when the park pawl has been properly disengaged and the vehicle is operating, determining whether there is a reason to secure the vehicle.

14. The method of claim 13, wherein the reason to secure the vehicle is a driver park request, and further comprising receiving, by the EVCU, the driver park request and requesting, by the EVCU, the PIM to engage the park pawl to secure the vehicle.

15. The method of claim 14, wherein the reason to secure the vehicle is based on an EVCU securement strategy that further comprises determining, by the EVCU, a need to secure the vehicle for safety reasons and requesting, by the EVCU, the PIM to engage the park pawl to secure the vehicle.

16. The method of claim 14, wherein the reason to secure the vehicle is an EVCU malfunction of the plurality of different electrical system malfunctions, and further comprising controlling, by the PIM, the park pawl and engaging, by the PIM, the park pawl in response to a driver shift to park or a calibratable timeout to secure the vehicle.

17. The method of claim 14, wherein the reason to secure the vehicle is a PIM malfunction of the plurality of different electrical system malfunctions, and further comprising requesting, by the EVCU, the electronic park brake to apply the braking force to the driveline of the vehicle to secure the vehicle.

18. The method of claim 14, wherein the reason to secure the vehicle is a system wide 12 volt loss malfunction of the plurality of different electrical system malfunctions.

19. The method of claim 18, wherein when the vehicle speed is greater than a threshold, the PIM uses back EMF of the EV electric motor and stores energy in the supercapacitor and the PIM then engages the park pawl when the vehicle speed falls below the threshold to secure the vehicle using the stored energy in the supercapacitor.

20. The method of claim 18, wherein when the speed is less than a threshold, the PIM controls the park pawl and receives power from a high voltage battery system of the vehicle and the PIM engages the park pawl when the vehicle speed is less than the threshold to secure the vehicle.
